(19) United States
(12) Patent Application Publication
(10) Pub. No.: US 2015/0239430 A1
(43) Pub. Date: Aug. 27, 2015

(54) REMOTE ANTI-THEFT SYSTEM FOR VEHICLES

(71) Applicant: MING-SHU SHIU, KINMEN COUNTY (TW)

(72) Inventor: MING-SHU SHIU, KINMEN COUNTY (TW)

(21) Appl. No.: 14/191,685

(22) Filed: Feb. 27, 2014

(51) Int. Cl. B60R 25/102; B60R 25/30

(52) U.S. Cl. CPC B60R 25/102; B60R 25/30

(57) ABSTRACT

A remote anti-theft system for vehicles is revealed. It comprises an anti-theft system having a processing unit and a power supply unit, wherein the processing unit is provided with a petrol reduction processing unit for controlling an engine to gradually reduce an amount of injected petrol and is connected with a wireless signal transmission unit for satellite positioning and wireless communication with a predetermined communication device.

### BACKGROUND OF THE INVENTION

1. Field of the Invention

The present invention relates to a remote anti-theft system for vehicles to prevent them from being driven away by thieves. It can not only control an engine to reduce an amount of injected petrol resulting in an insufficient fuel supply for drive, but also satellite position vehicles and periodically deliver location signal of the vehicles to predetermined communication devices, allowing owners to find their automobiles.

2. Description of Related Art

In recent years, carjacking cases have become increased so that vehicle owners cannot but find ways to solve the problem. Even though there are many locking devices developed for preventing thieves from stealing vehicles, it is also difficult to curb the high carjacking rate due to thieves simultaneously developing various tools for unlocking. Because automobiles can significantly save the transportation time between departure and destination and shelter people from the wind and the rain, now they are essential products in daily life. Accordingly, the vehicle theft problem is always what vehicle buyers most worried about.

Generally, mechanical anti-theft apparatuses, such as coded lock or steering wheel lock, are difficult to work efficiently for vehicles. Therefore, electronic anti-theft apparatuses are developed, including a car battery jar, a buzzer, and an anti-theft main engine, wherein the anti-theft main engine electrically connects to a plurality of sensors, and the car battery jar electrically connects to the buzzer and the anti-theft main engine for providing them power. When any of sensors detects abnormal phenomenon, e.g. vehicle suffered damage, move or intrusion, the sensor will transmit sensing signal to the anti-theft main engine for controlling the buzzer to sound a warning or making lights flashing so as to frighten and hinder thieves. However, the electronic anti-theft apparatuses still have very limited anti-theft effect in use and need to be improved.

### SUMMARY OF THE INVENTION

In view of the above-mentioned problems, the object of the present invention is to provide a remote anti-theft system for vehicles to prevent them from being driven away by thieves. When an anti-theft system is actuated, it can not only control an engine to reduce an amount of injected petrol by a petrol reduction processing unit to cause an insufficient fuel supply for drive, but also position vehicles and periodically deliver location signal of the vehicles to predetermined communication devices by a wireless signal transmission unit, allowing owners to find their automobiles successfully.

Disclosed herein is a remote anti-theft system for vehicles, comprising an anti-theft system having a processing unit and a power supply unit, wherein the processing unit is provided with a petrol reduction processing unit for controlling an engine to gradually reduce an amount of injected petrol and is connected with a wireless signal transmission unit for satellite positioning and wireless communication with a predetermined communication device.

According to an embodiment of the present invention, the anti-theft system is built in an electronic control unit (ECU).

### BRIEF DESCRIPTION OF THE DRAWINGS

FIG. 1 is a block diagram of an anti-theft system according to the present invention;

FIG. 2 is a circuit diagram showing a processing unit according to the present invention;

FIG. 3 is a first circuit diagram showing a power supply unit according to the present invention;

FIG. 4 is a second circuit diagram showing a power supply unit according to the present invention;

FIG. 5 is a circuit diagram showing a petrol reduction processing unit according to the present invention;

FIG. 6 is a circuit diagram showing a wireless signal transmission unit according to the present invention;

FIG. 7 is a flow chart of the present invention in use.

### DETAILED DESCRIPTION OF THE PREFERRED EMBODIMENT

Hereinafter, an exemplary embodiment of the present invention will be described in detail with reference to the accompanying drawings.

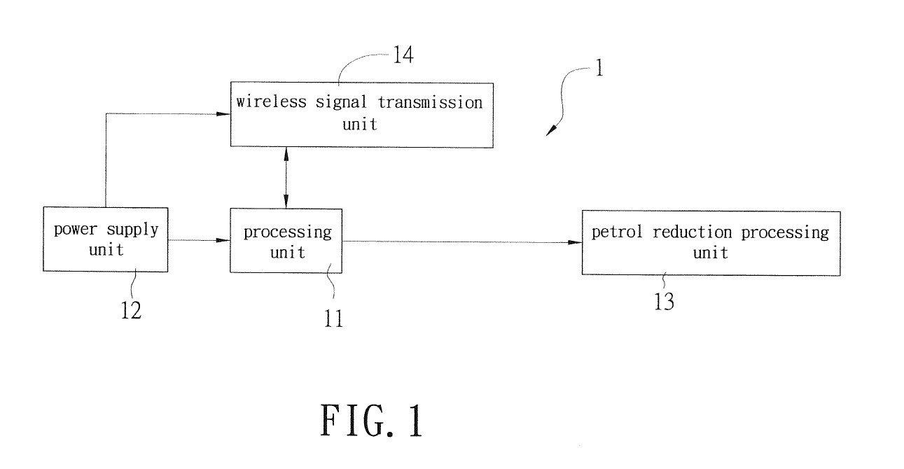

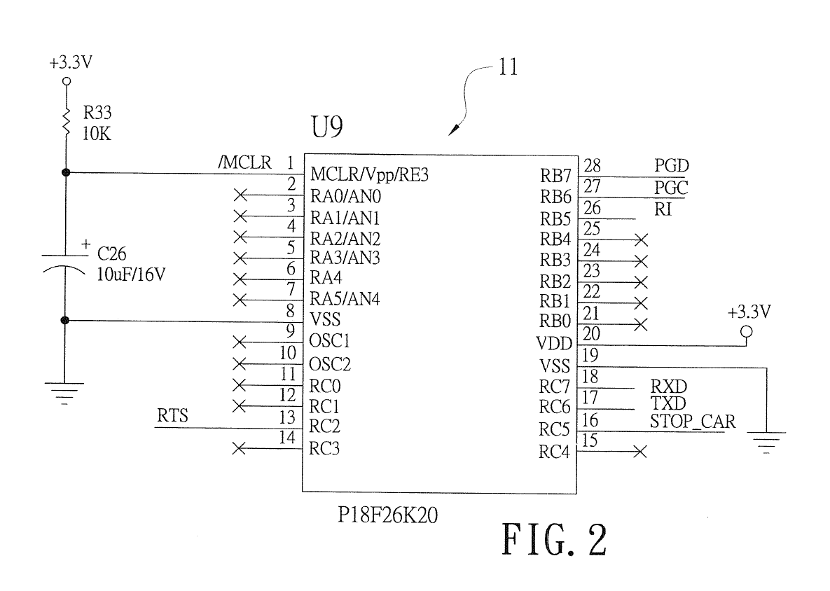

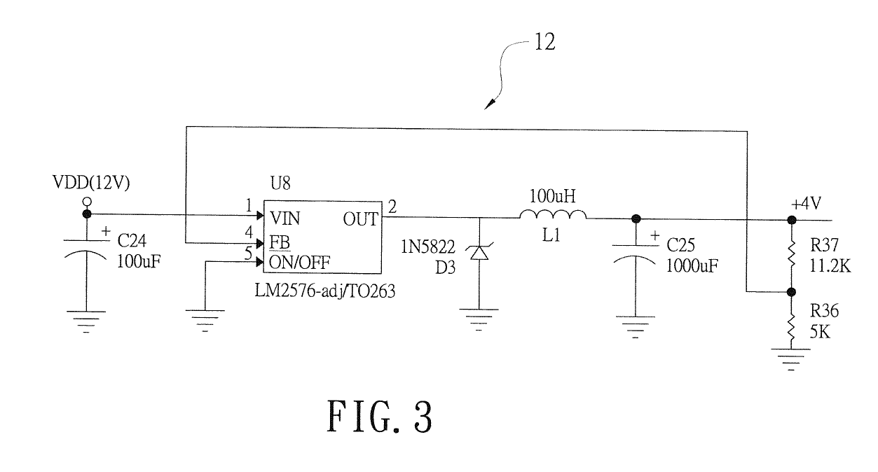

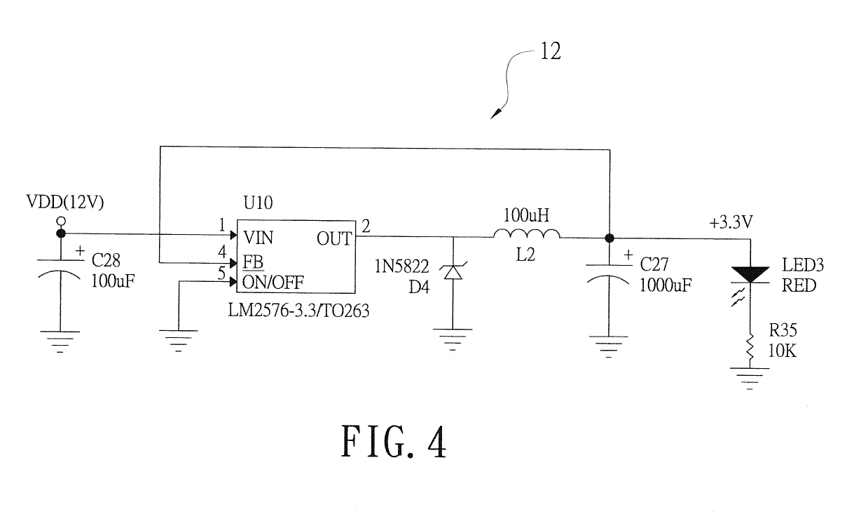

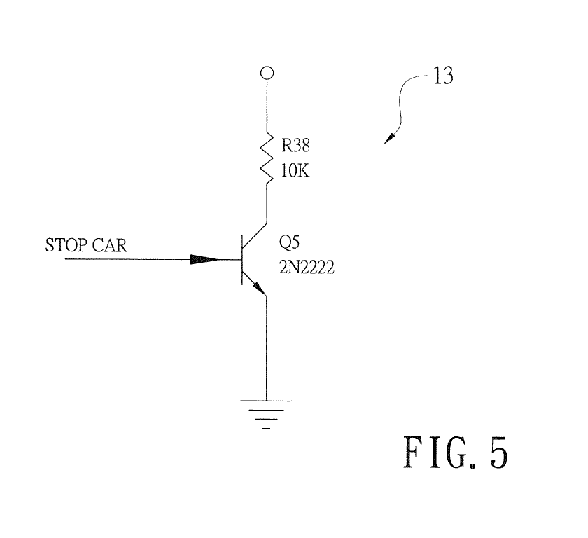

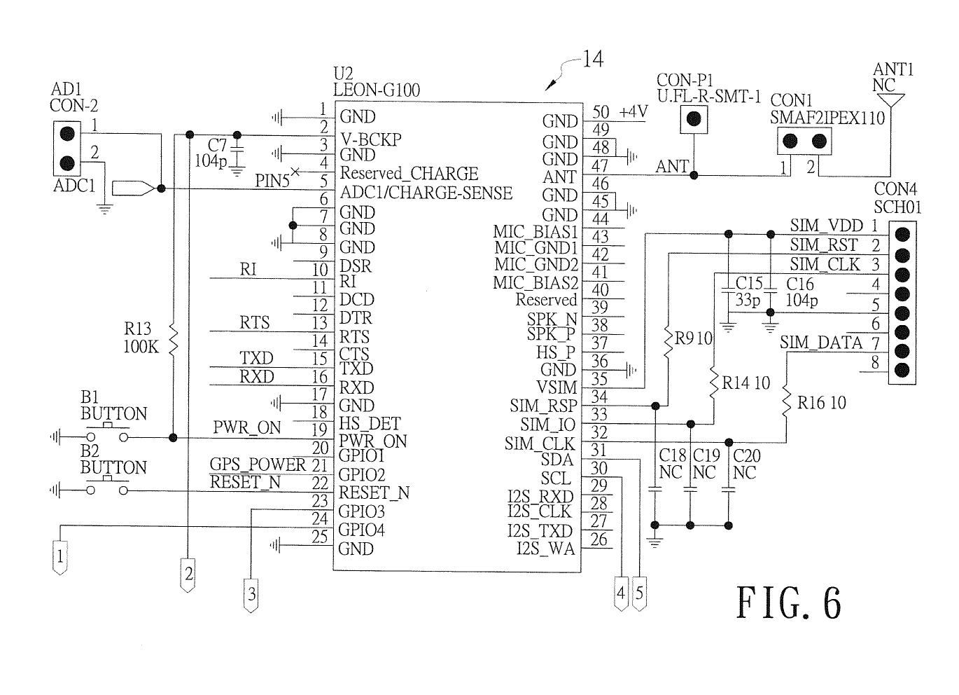

First, referring to FIG. 1, a block diagram of an anti-theft system according to the present invention is revealed. A remote anti-theft system for vehicles, comprising an anti-theft system (1) built in an electronic control unit (ECU) and having a processing unit (11) (referring to a circuit diagram showing a processing unit according to the present invention as shown in FIG. 2) and a power supply unit (12) (referring to a first and a second circuit diagrams showing a power supply unit according to the present invention as shown in FIG. 3 and FIG. 4), wherein the processing unit (11) is provided with a petrol reduction processing unit (13) (referring to a circuit diagram showing a petrol reduction processing unit according to the present invention as shown in FIG. 5) for controlling an engine to gradually reduce an amount of injected petrol and is connected with a wireless signal transmission unit (14) (referring to a circuit diagram showing a wireless signal transmission unit according to the present invention as shown in FIG. 6) for satellite positioning (such as by using the Global Positioning System (GPS)) and wireless communication with a predetermined communication device.

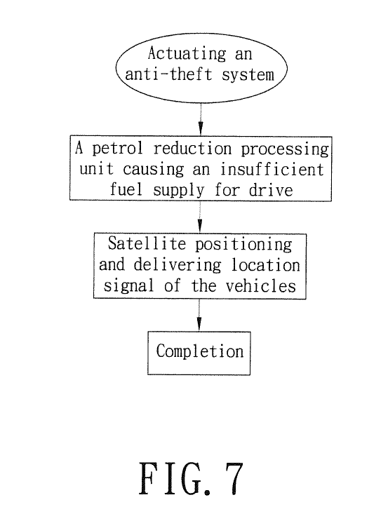

Referring to FIG. 7, a flow chart of the present invention in use is revealed. After an anti-theft system (1) is actuated, a processing unit (11) of the anti-theft system (1) can further actuate a petrol reduction processing unit (13) for controlling an engine to reduce an amount of injected petrol, leading to an insufficient fuel supply for drive. Moreover, a processing unit (11) of the anti-theft system (1) can actuate a wireless signal transmission unit (14) to satellite position vehicles and periodically deliver location signal of the vehicles to predetermined communication devices, allowing owners to find their automobiles successfully.

According to the above description, in comparison with the traditional technique, a remote anti-theft system for vehicles according to the present invention has the advantages as following:
1. The anti-theft system of the present invention equipped with a petrol reduction processing unit can efficiently prevent vehicles from being driven away by thieves through reducing an amount of injected petrol from an engine to cause an insufficient fuel supply for drive.
2. The wireless signal transmission unit of the present invention can not only satellite position vehicles but also deliver location signal of the vehicles to predetermined communication devices, allowing owners to find their automobiles successfully according to the message from the communication devices.

What is claimed is:

1. A remote anti-theft system for vehicles, comprising an anti-theft system having a processing unit and a power supply unit, wherein the processing unit is provided with a petrol reduction processing unit for controlling an engine to gradually reduce an amount of injected petrol and is connected with a wireless signal transmission unit for satellite positioning and wireless communication with a predetermined communication device.

2. As the remote anti-theft system for vehicles claimed in claim 1, wherein the anti-theft system is built in an electronic control unit (ECU).
